(19) United States
(12) Patent Application Publication
(10) Pub. No.: US 2008/0150203 A1
(43) Pub. Date: Jun. 26, 2008

(54) NOISE ISOLATION SYSTEM FOR A HYDROMOUNT

(76) Inventors: Hamid Mir, Rochester Hills, MI (US); Jerry R. Balogh, Farmington Hills, MI (US); Eric F. de Hesselle, Oxford, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 11/615,233

(22) Filed: Dec. 22, 2006

(51) Int. Cl. F16F 9/00; F16M 13/00; B60K 5/00

(52) U.S. Cl. 267/140.11; 248/562; 180/291

(57) ABSTRACT

A noise isolation system for damping a mounting structure that couples a powertrain of a motor vehicle to a frame of the motor vehicle includes an isolator having a first surface and a second surface. The isolator is coupled to the mounting structure such that the first surface is adjacent to the mounting structure. The noise isolation system further includes a washier coupled to the mounting structure. The washer is coupled to the mounting structure such that the washer is between the second surface of the isolator and the frame.

### FIELD

The present disclosure relates to engine mounting systems, and more particularly to a noise isolation system for a hydromount.

### BACKGROUND

The statements in this section merely provide background information related to the present disclosure and may not constitute prior art.

Most motor vehicles employ a combustion driven powertrain, such as a powertrain comprising an internal combustion engine. The internal combustion engine is typically mounted to a frame of the motor vehicle via a suitable mounting structure, such as an engine mount. The engine mounts need to be capable of reducing both the noise and the vibration caused by the operation of the engine to provide a pleasing driving experience to the operator of the motorvehicle. Generally, hydromounts have been employed as engine mounts, as they are capable of damping some of the vibrations and noise associated with the operation of the engine. However, most hydromounts are not capable of damping high frequency noise, such as the high frequency noise generated during the operation of a diesel internal combustion engine.

Accordingly, it would be desirable to provide a noise isolation system for a hydromount that is more efficient at damping high frequency noise.

### SUMMARY

A noise isolation system for damping a mounting structure that couples a powertrain of a motor vehicle to a frame of the motor vehicle is provided. The noise isolation system includes an isolator having a first surface and a second surface. The isolator is coupled to the mounting structure such that the first surface is adjacent to the mounting structure. The noise isolation system further includes a washer coupled to the mounting structure. The washer is coupled to the mounting structure such that the washer is between the second surface of tie isolator and the frame.

Further areas of applicability will become apparent from the description provided herein. It should be understood that the description and specific examples are intended for purposes of illustration only, and are not intended to limit the scope of the present disclosure

### DRAWINGS

The drawings described herein are for illustration purposes only and are not intended to limit the scope of the present disclosure in any way.

FIG. 1 is a partial view of an exemplary motor vehicle employing a hydromount incorporating a noise isolation system according to the principles of the present disclosure;

FIG. 1A is a detail view of the hydromount of FIG. 1 assembled to the motor vehicle;

FIG. 2 is a perspective view of one of embodiments for the noise isolation system for the hydromount of FIG. 1;

FIG. 3 is a cross-sectional view of the noise isolation system of FIG. 2; and

FIG. 4 is a perspective view of another of various embodiments for the noise isolation system for the hydromount of FIG. 1.

### DETAILED DESCRIPTION

The following description is merely exemplary in nature and is not intended to limit the present disclosures application, or uses. Although the following description is related generally to a noise isolation system for a hydromount for use as an engine mount in a motor vehicle, it will be understood that the noise isolation system as described and claimed herein is applicable to any type of mounting structure in which it is desired to further isolate noise and vibration. Therefore, it will be understood that the following discussion is not intended to limit the scope of the appended claims to only motor vehicles or hydromount applications.

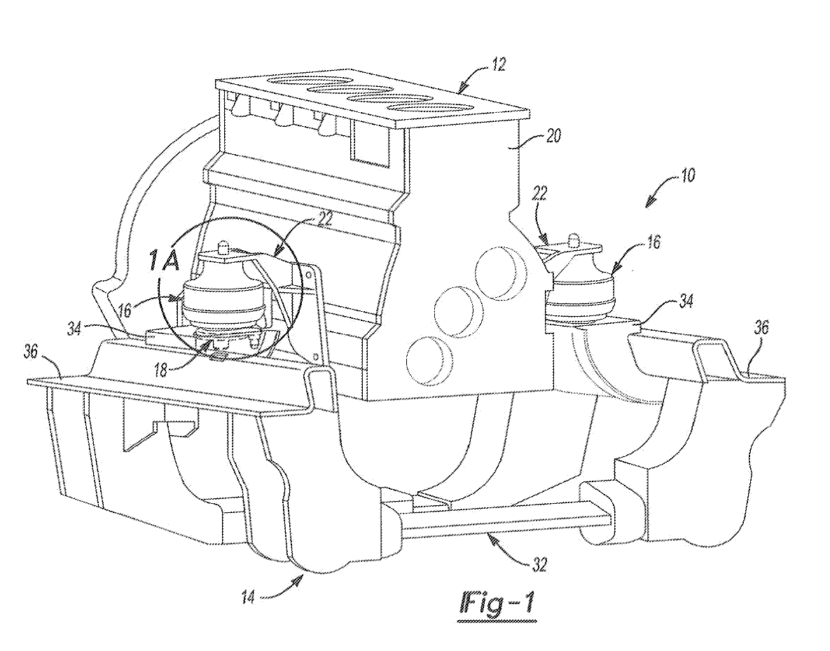

With reference to FIGS. 1 and 1A, an exemplary motor vehicle 10 is shown. The motor vehicle 10 includes a powertrain 12 coupled to a frame 14 via one or more mounting structures or hydromounts 16 that each include a nose isolation system 18. The powertrain 12 may include an engine 20 and one or more input brackets 22. It should be noted, however, that the powertrain 12 may include various additional components, such as a torque converter and a transmission or transaxle, as is generally known in the art (not specifically shown). The engine 20 combusts an air and fuel mixture within cylinders (not shown) to produce drive torque. Air is drawn into the engine 20 through a throttle (not shown). The fuel mixture may comprise any suitable combustible fuel such as hydrogen, gasoline, ethanol, methanol, propane or diesel, etc. The torque converter, if employed, transfers and multiplies torque from the engine 20 to the transmission (not shown). The transmission or transaxle, in turn, transfers torque to propel the motor vehicle 10 based on a desired speed (not shown).

With reference, to FIG. 1A, the input brackets 22 include a base 24 and an arm 26. The base 24 is fixedly coupled to the engine 20 via mechanical fasteners 28 (FIG. 1A). It should be noted, however, any suitable mechanism could be employed to couple the base 24 to the engine 20, such as welding or bonding, or the base 24 could be molded to or integrally formed with the engine 20. The arm 26 extends outwardly from the base 24 and defines an opening 30. The opening 30 is sized to receive the hydromount 16 to couple the arm 26 to the hydromount 16, and thus, the engine 20 to the frame 14, as will be discussed herein.

The frame 14 includes a cradle 32 and a cradle bracket 34 (FIG. 1). The cradle 32 provides support for the powertrain 12, and may provide attachment points for the various components of the powertrain 12 (not shown). The cradle includes a cross-beam 36 that provides an attachment point for the cradle bracket 34. The cradle bracket 34 may be mechanically coupled to the cross-beam 36, through fasteners, welding or adhesives, and alternatively, could be integrally formed or molded with the cross-beam 36. The cradle bracket 34 defines a concave surface 38, a first opening 40 and a second opening 42. The concave surface 38, first opening 40 and a second opening 42 each receive at least a portion of the hydromount 16 or noise isolation system 18 to couple the powertrain 12 to the frame 14 via the hydromount 16 as will be discussed herein.

With reference to FIG. 1A, the hydromount 16 includes a housing 44 that has a first member 46 at a first end 48, a second member 50 at a second end 52 and a damping system 55. The hydromount 16 may be any suitable hydromount 16, such as the hydromount described in U.S. Pat. No. 4,886,251, entitled “Hydraulically Damping Rubber Bearing Engine Mount”, filed Feb. 7, 1989, and incorporated herein in its entirety. In addition, the hydromount 16 could be provided by DTR America of Taylor, Mich. or Dongah Tire and Rubber Co., Ltd. of Yangsan-si, South Korea. As the hydromount 16 may be any suitable hydromount, the hydromount 16 will not be discussed in great detail herein. Briefly, however, the first member 46 and the second member 50 may be composed of a metal or a mental alloy, and the damping system 55 may comprise internal chambers that may be filled with a fluid, such as a silicon fluid. The damping system 55 damps or lessens the vibration and noise created by the engine 20. It should be understood, however, that any damping system 55 could be employed to damp the vibration and noise created by the engine 20, such as tuned air chambers.

The first member 46 at the first end 48 couples the hydromount 16 to the input bracket 22, while the second member 50 at the second end 52 couples the hydromount 16 to the cradle bracket 34. The first member 46 includes a first stud 54 that is sized to pass through the opening 30 of the input bracket 22 for receipt of a nut (not shown) to clamp the input bracket 22 to the hydromount 16.

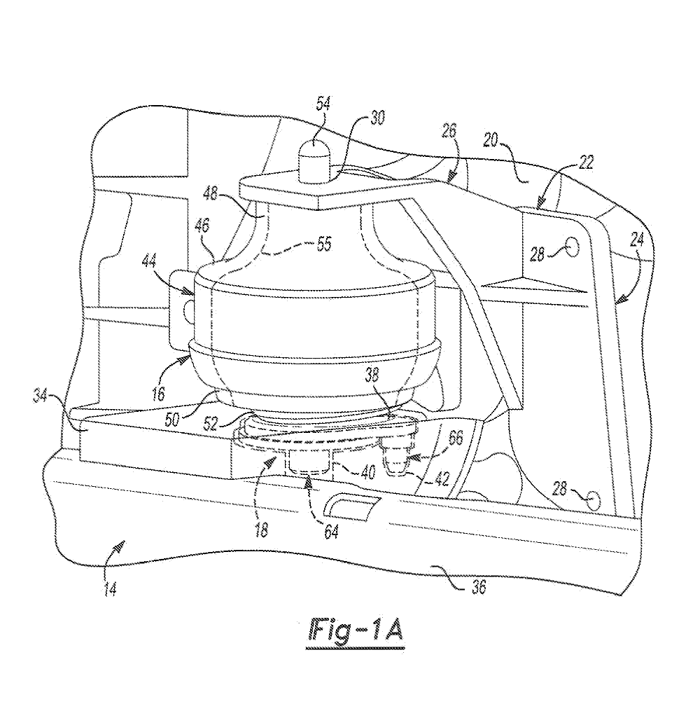

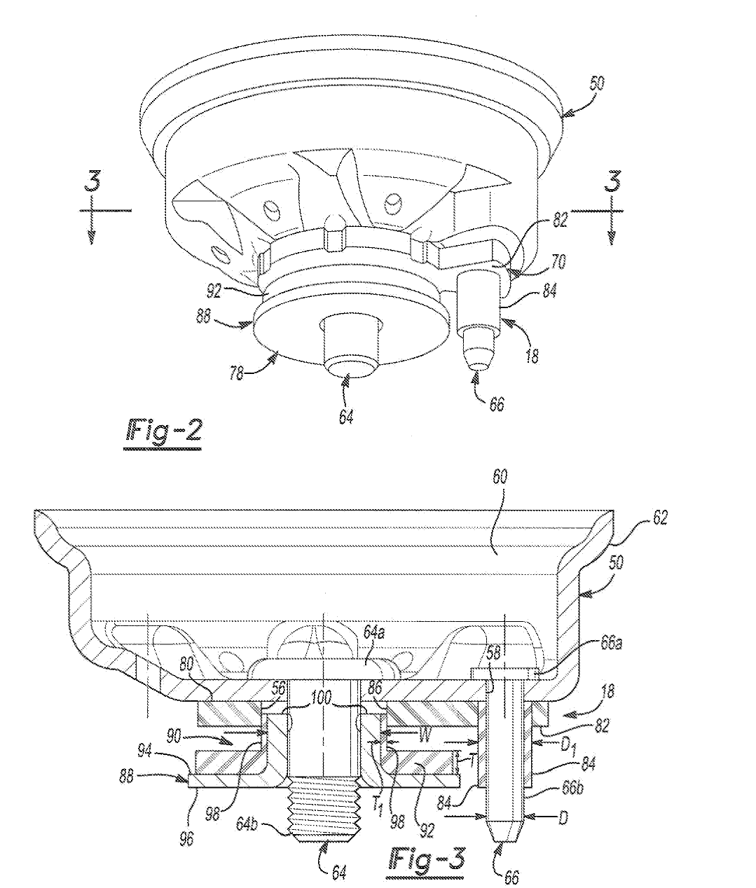

The second member 50 of the hydromount 16 is coupled to the noise isolation system 18. With reference to FIGS. 2 and 3, the second member 50 may be, a cup-shaped housing that defines a first opening 56, a second opening 58, an interior surface 60, an exterior surface 62 and includes a stud 64 and an anti-rotation pin 66. The first opening 56 receives the stud 64. The stud 64 includes a head 64a and a body 64b. The head 64a is sized to secure the stud 64 within the interior surface 60 of the second member 50, and the body 64b is sized for receipt of a portion of the noise isolation system 18, as will be discussed. In addition, the body 64b is sized to pass through the first opening 40 defined in the cradle bracket 34 of the frame 14 for receipt of a nut, for example (not shown), to clamp the second member 50 to the frame 14 via the stud 64.

The second opening 58 receives the anti-rotation pin 66. The anti-rotation pin 66 is sized to enter into the second opening 42 defined in the cradle bracket 34 of the frame 14. The anti-rotation pin 66 ensures that the hydromount 16 is properly positioned with respect to the frame 14 prior to the second member 50 being clamped to the frame 14. The anti-rotation pin 66 includes a head 66a and a body 66b. The head 66a is sized to secure the anti-rotation pin 66 within the interior surface 60 of the second member 50, and the body 66b is sized for receipt of a portion of the noise isolation system 18, as will be discussed.

The interior surface 60 of the second member 50 secures the stud 64 and anti-rotation pin 66 to the second member 50. The exterior surface 62 may be curved to facilitate the engagement of the second member 50 with the concave surface 38 of the cradle bracket 34 of the frame 14. In addition, the exterior surface 62 of the second member 50 is contoured for receipt of the noise isolation system 18.

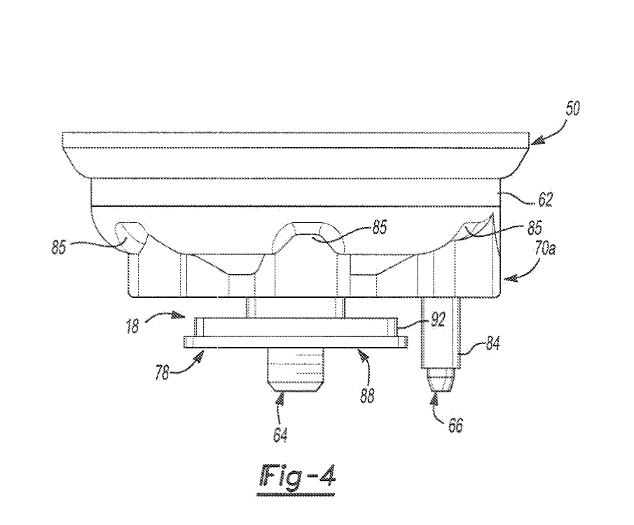

With reference to FIGS. 2 and 3, the noise isolation system 18 includes an isolator 70 and a washer 78. The isolator 70 may be composed of an elastomeric material such as natural rubber, for example. Generally, the isolator 70 may be independently formed and frictionally coupled adjacent to the exterior surface 62 of the second member 50. Alternatively, shown in FIG. 4, an isolator 70a may be integrally molded onto the exterior surface 62 of the second member 50. If the isolator 70a is integrally molded onto the exterior surface 62 of the second member 50, then the isolator 70a may be secured to the exterior surface 62 by overmolding the elastomeric material onto the exterior surface 62 of the second member 50 such that the elastomeric material engages notches 85 formed on the exterior surface 62. As the isolator 70a is substantially similar to the isolator 70, except for the forming technique, the reference number 70 will be used to refer to both the isolator 70 and 70a throughout. With reference to FIGS. 2-4, the isolator 70 has a first surface 80, a second surface 82, a projection 84 and a throughbore 86.

The first surface 80 is adjacent to the exterior surface 62 of the second member 50 when the isolator 70 is coupled to the second member 50, and the second surface 82 is adjacent to the washer 78. The projection 84 extends from the second surface 82. The projection 84 may have an inner diameter D that is about slightly larger or about equal to a diameter D1 of the anti-rotation pin 66 such that the isolator 70 may be coupled to the second member 50 by press-fitting the projection 84 over the anti-rotation pin 66, it the isolator 70 is not overmolded onto the second member 50. Alternatively, the diameter D of the projection 84 may be tapered such that the force required to press-fit the projection 84 over the anti-rotation pin 66 increases as the projection 84 moves over the anti-rotation pin 66 into the assembled position (no shown). The projection 84 is generally sized such that the projection 84 covers about 50 to about 85 percent of a length of the anti-rotation pin 66. The throughbore 86 is sized for receipt of a portion of the washer 78 when the washer 78 is compressed against the isolator 70.

With reference back to FIGS. 2-4, the washer 78 includes a base 88, a protrusion 90 and an isolating layer 92. As best shown in FIG. 3, the base 88 is generally annular and has a first surface 94 and a second surface 96. The first surface 94 may be coated with the isolating layer 92 at a desired thickness T. The second surface 96 may be adjacent to the frame 14 to distribute the load applied during the clamping of the second member 50 to the frame 14. The protrusion 90 extends upwardly from a center of the base 88 and has a width W sized such that the protrusion 90 may contact the exterior surface 62 of the second member 50 if the isolating layer 92 is removed from the first surface 94.

The isolating layer 92 may be molded onto the first surface 94 of the washer 78, but generally, the isolating layer 92 may be independently formed and coupled to the first surface 94 of the washer 78. It, addition, the isolating layer 92 may cover a portion or an entirety of the protrusion 90. Generally, the isolating layer 92 covers a side 98 of the protrusion 90 but does not cover a top surface 100 of the protrusion 90, such that in the case that the isolating layer 92 is removed, there is metal to metal contact between the top of the washer 78 and the second member 50. The thickness T1 of the isolating layer 92 on the protrusion 90 is about 10 to about 50 percent of a thickness T of the isolating layer 92 on the first surface 80 of the base 88. The isolating layer 92 may be formed of an elastomeric material, such as natural rubber.

In order to assemble the noise isolation system 18 to the hydromount 16, if the isolator 70 is molded independent of the second member 50, then the projection 74 of the isolator 70 may be pressfit onto the anti-rotation pin 66 of the second member 50, until the first surface 72 of the isolator 70 is adjacent to the exterior surface 62 of the second member 50. Alternatively, if the isolator 70 is molded to the exterior surface 62 of the second member 50, as shown in FIG. 4, then the isolator 70 is molded around the anti-rotation pin 66. In either case, after the isolator 70 is secured to the second member 50, the washer 78 may be slid onto the stud 64 until the isolating layer 92 on the first surface 94 of the base 88 of the washer 78 is spaced a pre-determined distance from the second surface 76 of the isolator 70, such as 0.5 to 3 millimeters (mm). Once the noise isolation system 18 is secured to the second member 50 of the hydromount 16, the hydromount 16 may then be clamped to the input bracket 22 and the cradle bracket 34 via the studs 54, 64. When the hydromount 16 is clamped to the engine 20 and the frame 14, the hydromount 16 absorbs the vibration and noise associated with the operation of the engine 20.

The noise isolation system 18, when coped to the hydromount 16, may further reduce the high frequency noise associated with the operation of the engine 20. For example, in the case of a diesel engine 20, the noise isolation system 18 reduces the high frequency noise, such as noise within about 500 Hertz (Hz) to about 1700 Hz, generated by the engine 20 to about 50 to about 80 percent. Thus, the noise isolation system 18 provides a noise isolation system for the hydromount 16 that is more efficient at damping high frequency noise.

While specific examples have been described in the specification and illustrate in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out this disclosure, but that the scope of the present disclosure will include any embodiments falling within the foregoing description and the appended claims.

What is claimed is:

1. A noise isolation system for damping a mounting structure that couples a powertrain of a motor vehicle to a frame of the motor vehicle comprising:
an isolator having a first surface and a second surface, the isolator coupled to the mounting structure such that the first surface s adjacent to the rotating structure; and
a washer coupled to the mounting structure such that the washer is between the second surface of the isolator and the frame.

2. The nose isolation system of claim 1, wherein the mounting structure comprises a hydromount that includes:
an anti-rotation pin coupled to the hydromount that extends through a first opening defined in the surface of the hydromount to position the hydromount on the frame; and
a stud coupled to the hydromount that extends through a second opening defined in the surface of the hydromount such that the stud passes through a third opening defined in the frame to enable the receipt of a nut to clamp the hydromount to the frame.

3. The noise isolation system of claim 2, wherein the first surface of the isolator is adjacent to the surface of the hydromount, the second surface of the isolator includes a projection that extends from the second surface for receipt of the anti-rotation pin to couple the isolator to the hydromount, and the washer is slidably coupled to the stud, with the washer having a base including a first surface and a second surface, the first surface including an isolating layer that contacts the isolator, while the second surface contacts the frame.

4. The mounting structure of claim 3, wherein the isolator is separately molded and frictionally coupled to the hydromount.

5. The mounting structure of claim 3, wherein the isolator is molded onto the surface of the hydromount.

6. The mounting structure of claim 3, wherein the isolator and the isolating layer are composed of an elastomeric material.

7. The mounting structure of claim 3, wherein the isolator defines an aperture and the washer includes a protrusion extending from the base and sized to be received in the aperture, the protrusion including a top surface and a side surface, at least a portion of the side surface coated by the isolating layer.

8. The mounting structure of claim 7, where n a distance between the top surface of the base and the second surface of the isolator is selected to provide a pro-determined amount of stiffness for the hydromount with regard to the frame.

9. A mounting structure for coupling a powertrain of a motor vehicle to a frame of the motor vehicle comprising:
a first member coupled to the powertrain;
a second member coupled to the frame, the second member including a surface;
a damping system coupled to the first member and the second member to enable the first member to translate with respect to the second member; and
a noise isolation system disposed between the second member and the frame, the noise isolation system an isolator coupled to the surface of the second member.

10. The mounting structure of claim 9, wherein the second member further comprises:
an anti-rotation pin coupled to the second member that extends through a first opening defined in the surface of the second member to position the second member on the frame; and
a stud coupled to the second member that extends through a second opening defined in the surface of the second member such that the stud passes through a third opening defined in the frame to enable the receipt of a nut to clamp the second member to the frame.

11. The mounting structure of claim 10, wherein the isolator further comprises:
a first surface adjacent to the surface of the second member in an assembled position; and
a second surface including a protection that extends from the second surface for receipt of the anti-rotation pin to couple the isolator to the second member.

12. The mounting structure of claim 11, wherein the noise isolation system further comprises:
a washer slidably coupled to the, stud the washer having a base and a protrusion that extends from the base, the base including a first surface and a second surface, the first surface including an isolating layer adjacent to the second surface of the isolator, and the protrusion is sized to be received in an aperture defined within the isolator, with the protrusion having a side surface with at least a portion of the side surface coated by the isolating layer.

13. The mounting structure of claim 9, wherein the isolator is separately molded and frictionally coupled to the second member.

14. The mounting structure of claim 9, wherein the isolator is molded onto the surface of the second member.

15. The mounting structure of claim 12, wherein a distance between the top surface of the base and the second surface of the isolator is selected to provide a pre-determined amount of stiffness for the second member with regard to the frame.

16. A motor vehicle comprising;
a frame;
a powertrain coupled to the frame by a mounting structure the mounting structure including:
a housing having a first end coupled to the powertrain and a second end coupled to the frame;
a damping system disposed in the housing to enable the first end to translate with respect to the second end; and
a noise isolation system coupled to the second end such that the noise isolation system is disposed between the second end and the frame.

17. The motor vehicle of claim 18, wherein the housing further comprises;
a first member coupled to the powertrain;
a second member coupled to the first member and the frame, the second member including;
an anti-rotation pin that extends through a first opening defined in the surface of the second member to position the second member on the frame; and
a stud that extends through a second opening defined in the surface of the second member such that the stud passes through a third opening defined in the frame to enable the receipt of a nut to clamp the second member to the frame.

18. The motor vehicle of claim 17, wherein the noise isolation system further comprises:
an isolator having a first surface and a second surface, the first surface adjacent to the surface of the second member in an assembled position, the second surface including a projection that extends from the second surface for receipt of the anti-rotation pin to couple the isolator to the second member; and
a washer slidably coupled to the stud, the washer having a base including a first surface and a second surface, the first surface including an isolating layer that contacts the isolator in an assembled position, while the second surface contacts the frame.

19. The motor vehicle of claim 17, wherein the isolator is separately molded and frictionally coupled to the second member.

20. The motor vehicle of claim 17, wherein the isolator is molded onto the surface of the second member.
